(19) United States
(12) Patent Application Publication
(10) Pub. No.: US 2024/0193920 A1
(43) Pub. Date: Jun. 13, 2024

(54) METHOD FOR PREDICTING USER PERSONALITY BY MAPPING MULTIMODAL INFORMATION ON PERSONALITY EXPRESSION SPACE

(71) Applicant: Korea Electronics Technology Institute, Seongnam-si (KR)

(72) Inventors: Jae Woong YOO, Seongnam-si (KR); Mi Ra LEE, Hwaseong-si (KR); Hye Dong JUNG, Seoul (KR)

(73) Assignee: Korea Electronics Technology Institute, Seongnam-si (KR)

(21) Appl. No.: 18/536,536

(22) Filed: Dec. 12, 2023

(30) Foreign Application Priority Data
Dec. 13, 2022 (KR) 10-2022-0173458
Mar. 21, 2023 (KR) 10-2023-0036766

(51) Int. Cl. G06V 10/77; G06V 10/44; G06V 10/764; G06V 10/80; G06V 40/20; G10L 15/02; G10L 15/08

(52) U.S. Cl. CPC G06V 10/7715; G06V 10/44; G06V 10/764; G06V 10/806; G06V 40/20; G10L 15/02; G10L 15/08

(57) ABSTRACT

There is provided a method for predicting a user personality by mapping multimodal information on a personality expression space. A personality prediction method according to an embodiment extracts a multimodal feature from an input image in which a user appears, maps the extracted multimodal feature on a personality expression space, and predicts a personality of the user based on a result of mapping. Accordingly, a personality of a user may be more exactly predicted through establishment of a correlation between user's various behavior characteristics and personalities.

### CROSS-REFERENCE TO RELATED APPLICATION(S) AND CLAIM OF PRIORITY

This application is based on and claims priority under 35 U.S.C. § 119 to Korean Patent Application No. 10-2022-0173458, filed on Dec. 13, 2022, and Korean Patent Application No. 10-2023-0036766, filed on Mar. 21, 2023, in the Korean Intellectual Property Office, the disclosure of which is herein incorporated by reference in its entirety.

### BACKGROUND

### Field

The disclosure relates to an image-based personality prediction method, and more particularly, to a method and a system for predicting a personality of a user by using multimodal information acquired from an image in which the user appears.

### Description of Related Art

Thanks to the convergence of platforms and development of technologies, user-customized services which understand attributes of humans and suggest technologies most appropriate or suited to environments are enhanced rapidly.

Accordingly, definitions and meaning of computing, interfaces, etc. between a user and a system are extended, and the field of interaction between humans and computers perform an important role in researching ways of enabling users to interact with systems easily and comfortably.

In particular, as hardware capable of storing and utilizing huge amounts of data is rapidly developing, the importance of a task of understanding users' behavior and emotion and predicting by using personal information of users is stressed.

A human personality may be an essential element to understand and predict a user, and may be an index for expressing a human changing every time. Accordingly, there is a need for a solution for predicting a variable personality of a user which is exhibited in various environments.

Methods for predicting user's personality by recognizing a facial area by using a text, an audio, image information of a user and utilizing as modality to extract information, or by recognizing an ambient object are being attempted. However, such methods are limited to information that is directly acquired from input data and thus have a problem of low prediction accuracy.

### SUMMARY

The disclosure has been developed in order to solve the above-described problems, and an object of the disclosure is to provide, as a solution for predicting user's personality more exactly, a method of mapping features extracted from multimodal information on a personality expression space and generating a decision boundary, and using the decision boundary in predicting user's personality, and a system applying the same.

According to an embodiment of the disclosure to achieve the above-described object, a personality prediction method may include: a step of extracting a multimodal feature from an input image in which a user appears; a step of mapping the extracted multimodal feature on a personality expression space; and a step of predicting a personality of the user based on a result of mapping.

The personality expression space may be a space that is constituted by a plurality of personality indexes. The step of mapping may be performed based on a result of analyzing a correlation between the multimodal feature and corresponding personality indexes. the correlation analysis is performed through CCA.

The personality expression space may be classified by decision boundaries. The step of predicting may include predicting a personality based on a class of a space which is classified by a mapped point.

The step of extracting may include: a step of extracting multimodal information from an input image; a step of extracting features from the extracted multimodal information; and a step of generating a multimodal feature by merging the extracted features. The multimodal information may include visual information, voice information, and text information. The text information may include an utterance text and caption information.

According to another embodiment of the disclosure, a personality prediction system may include: an extraction unit configured to extract a multimodal feature from an input image in which a user appears; a mapping unit configured to map the extracted multimodal feature on a personality expression space; and a prediction unit configured to predict a personality of the user based on a result of mapping.

According to still another embodiment of the disclosure, a personality prediction method may include: a step of mapping a multimodal feature extracted from an input image in which a user appears on a personality expression space which is classified by decision boundaries; and a step of predicting a personality of the user based on a result of mapping.

According to yet another embodiment of the disclosure, a personality prediction system may include: a mapping unit configured to map a multimodal feature extracted from an input image in which a user appears on a personality expression space which is classified by decision boundaries; and a prediction unit configured to predict a personality of the user based on a result of mapping.

According to embodiments of the disclosure as described above, by mapping features extracted from multimodal information on a personality expression space and generating decision boundaries, and by using in predicting a user personality, the user's personality may be more exactly predicted through establishment of a correlation between user's various behavior characteristics and personalities.

According to embodiments of the disclosure, by using a text including utterance contents and caption information as modalities in addition to visual information and voice information in an image in which a user appears, not only local information in the image but also general information of the image may be utilized in predicting a personality.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a personality prediction system according to an embodiment of the disclosure;

FIG. 2 is a view illustrating a multimodal feature extraction method;

FIG. 3 is a view illustrating a modality feature vector integration method; and

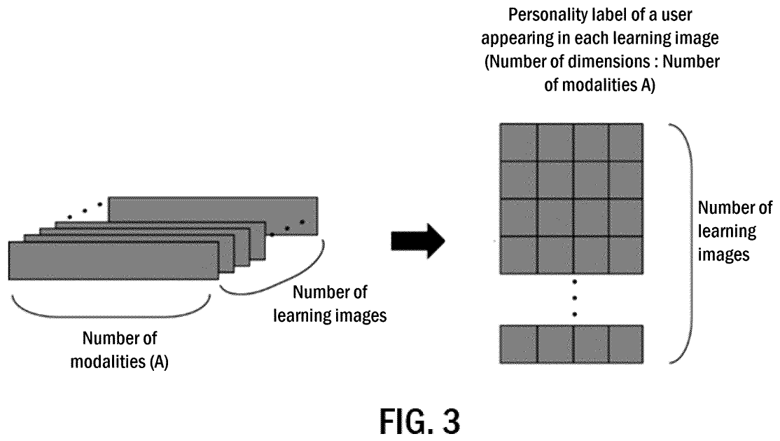

FIG. 4 is a concept view illustrating mapping multimodal features on personality indexes.

### DETAILED DESCRIPTION

Hereinafter, the disclosure will be described in more detail with reference to the accompanying drawings.

Embodiments of the disclosure provide a method of mapping features extracted from multimodal information on a personality expression space and generating a decision boundary, and using the decision boundary in predicting user's personality, and a system applying the same.

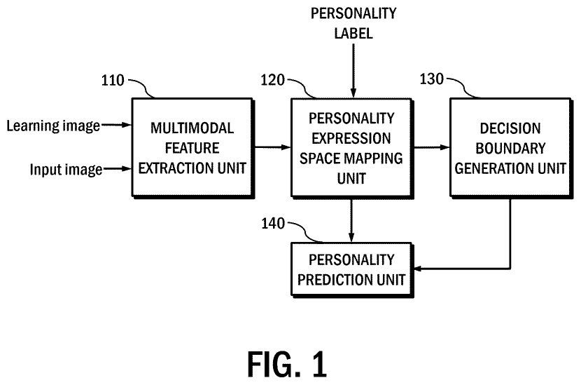

FIG. 1 is a view illustrating a configuration of a personality prediction system according to an embodiment of the disclosure. As shown in FIG. 1, the personality prediction system according to an embodiment may include a multimodal feature extraction unit 110, a personality expression space mapping unit 120, a decision boundary generation unit 130, and a personality prediction unit 140.

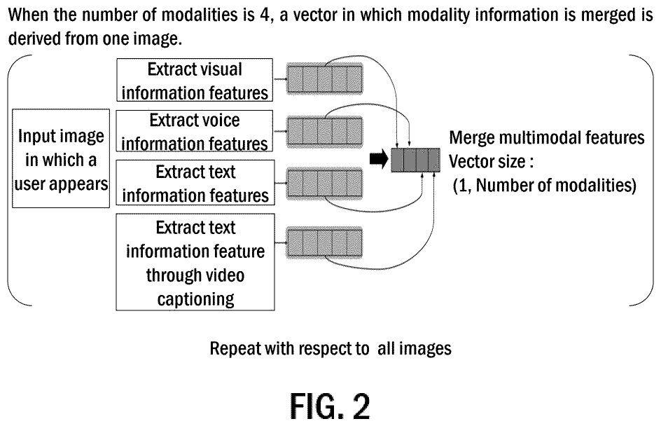

The multimodal feature extraction unit 110 may extract multimodal features from learning images. An operation/function of the multimodal feature extraction unit 110 will be described with reference to FIG. 2. FIG. 2 is a view illustrating a multimodal feature extraction method.

First, a learning process will be described. A user appears in a learning image. The multimodal feature extraction unit 110 may extract multimodal information from the learning image in which the user appears, and the extracted multimodal information may include visual information, voice information, and text information.

The visual information refers to information on a facial area, an ambient environment or a background area extracted from the learning image. The voice information is an uttered voice of the user that is extracted from the learning image. The text information includes an utterance text and caption information.

The utterance text is a text that is generated by converting an uttered voice of the user through speech-to-text (STT), and the caption information is a text indicating a facial expression of the user, an ambient object, a situation which are derived from the learning image through video captioning.

The multimodal feature extraction unit 110 extracts features regarding visual information, voice information, utterance text, caption information which are multimodal information. Various machine learning models or algorithms may be used to extract features. For example, in the case of voice information, a Mel-frequency cepstral coefficient (MFCC) algorithm may be used.

Thereafter, the multimodal feature extraction unit 110 may merge the extracted multimodal features into one feature vector. In order to merge the extracted multimodal features into one feature vector, the multimodal feature extraction unit 110 may average the multimodal features and may convert the average into one vector element. Specifically, features of visual information may be averaged and converted into one element, features of voice information may be averaged and may be converted into one element, features of an utterance text may be averaged and converted into one element, and features of caption information may be averaged and converted into one element.

The multimodal feature vector merged as described above is a modality feature vector for one learning image, and may have a size of 1×A (number of modalities). In the example illustrated in FIG. 2, A is 4.

Since a plurality of learning images are provided, the multimodal feature extraction unit 110 repeats the above-described procedure with respect to the plurality of learning images to generate a plurality of modality feature vectors, and may integrate the modality feature vectors. Since the size of the modality feature vector for one learning image is 1×A, a size of a modality feature vector generated/integrated for the plurality of learning images is N (number of learning images)×A.

Referring back to FIG. 1, the personality expression space mapping unit 120 may map the modality feature vector extracted by the multimodal feature extraction unit 110 on a personality expression space which is a space for expressing a personality.

The personality expression space is a space that is generated by personality indexes. OCEAN (big five factors) may be utilized as personality indexes. Herein, O is an index representing openness to experience, C is an index representing conscientiousness, E is an index representing extraversion, A is an index representing agreeableness, and N is an index representing neuroticism.

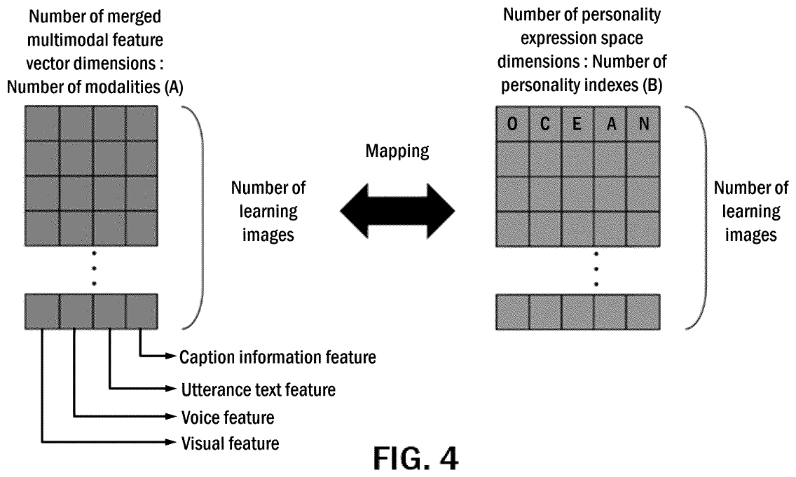

In this case, the personality expression space may be a 5-dimensional space. FIG. 4 illustrates a concept of mapping (converting) multimodal features on (into) personality indexes O, C, E, A, N by the personality expression space mapping unit 120. Since multimodal features are 4-dimensional data and OCEAN data is 5-dimensional data, dimension mapping may be performed in this process due to the different data dimension.

At a learning step, O, C, E, A, N indexes which are personality indexes may be given as labels along with the learning image, and the personality expression space mapping unit 120 may identify a correlation between multimodal features and personality indexes by using canonical correlation analysis (CCA). Since a plurality of learning images are provided, the personality expression space mapping unit 120 may repeat the above-described procedure with respect to a plurality of multimodal features and personality indexes.

Referring back to FIG. 1, the decision boundary generation unit 130 may generate decision boundaries for classifying personalities in the personality expression space on which all of the personality indexes of the learning data set are mapped. The decision boundaries may be generated by using a supervised learning-based classification and regression model, for example, a support vector machine (SVM).

A class (type) of a personality may be given to every space of the personality expression space which is classified by the decision boundaries. The personality expression space classified by the decision boundaries may be used to predict (infer) a personality of a user.

Hereinafter, a personality prediction (inference) process will be described.

The multimodal feature extraction unit 110 may extract multimodal information from an input image, and may generate a multimodal feature vector by extracting features from the multimodal information and then mering the features. The multimodal information may include visual information, voice information, and text information, and the text information may include an utterance text and caption information.

The personality expression space mapping unit 120 may map the modality feature vector extracted by the multimodal feature extraction unit 110 on a personality expression space based on a correlation identified through CCA.

The personality prediction unit 140 may predict a personality of a user by classifying a personality class of the user by identifying in which space a point mapped on the personality expression space by the personality expression mapping unit 120 is positioned by decision boundaries generated by the decision boundary generation unit 130.

Up to now, a method for predicting a user personality by mapping multimodal information on a personality expression space has been described with reference to preferred embodiments.

In an embodiment of the disclosure, by embedding modality information extracted from an image in which a user appears in a space constituted with indexes for expressing user's personality, and clustering, a correlation between modality information and user's personality may be quantified, and a personality may be predicted from user's behavior based on the correlation.

Furthermore, in an embodiment of the disclosure, by adding an utterance text and a text generated through video captioning to modality information in addition to visual information and voice information of an image in which a user appears, bias in information of the modality may be reduced and accuracy of personality prediction may be enhanced.

A personality of a user which is a prediction target in an embodiment of the disclosure is merely an example. When other features than a personality of a user are predicted, the technical idea of the disclosure may be applied.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A personality prediction method comprising:
a step of extracting a multimodal feature from an input image in which a user appears;
a step of mapping the extracted multimodal feature on a personality expression space; and
a step of predicting a personality of the user based on a result of mapping.

2. The personality prediction method of claim 1, wherein the personality expression space is a space that is constituted by a plurality of personality indexes.

3. The personality prediction method of claim 2, wherein the step of mapping is performed based on a result of analyzing a correlation between the multimodal feature and corresponding personality indexes.

4. The personality prediction method of claim 3, wherein the correlation analysis is performed through CCA.

5. The personality prediction method of claim 2, wherein the personality expression space is classified by decision boundaries.

6. The personality prediction method of claim 5, wherein the step of predicting comprises predicting a personality based on a class of a space which is classified by a mapped point.

7. The personality prediction method of claim 1, wherein the step of extracting comprises:
a step of extracting multimodal information from an input image;
a step of extracting features from the extracted multimodal information; and
a step of generating a multimodal feature by merging the extracted features.

8. The personality prediction method of claim 7, wherein the multimodal information includes visual information, voice information, and text information.

9. The personality prediction method of claim 8 wherein the text information includes an utterance text and caption information.

10. A personality prediction system comprising:
an extraction unit configured to extract a multimodal feature from an input image in which a user appears;
a mapping unit configured to map the extracted multimodal feature on a personality expression space; and
a prediction unit configured to predict a personality of the user based on a result of mapping.

11. A personality prediction method comprising:
a step of mapping a multimodal feature extracted from an input image in which a user appears on a personality expression space which is classified by decision boundaries; and
a step of predicting a personality of the user based on a result of mapping.
